(19) United States
(12) Patent Application Publication
(10) Pub. No.: US 2003/0162565 A1
(43) Pub. Date: Aug. 28, 2003

(54) Method for processing transactions by means of wireless devices

(76) Inventor: Ali Hassan Al-Khaja, Tubli (BH)

Correspondence Address: Karl F. Milde, Jr., Esq., MILDE & HOFFBERG, L.L.P., Suite 460, 10 Bank Street, White Plains, NY, 10606, US

(21) Appl. No.: 10/357,164

(22) Filed: Jan. 31, 2003

(30) Foreign Application Priority Data
Feb. 28, 2002 (DE) 102 08 637.0

(51) Int. Cl. H04B 1/38; H04M 1/00; H04M 11/00

(52) U.S. Cl. 455/558; 455/556; 455/406; 455/407; 455/408

(57) ABSTRACT

In a method for processing financial transactions by means of wireless devices, especially devices for mobile communication, at least one device for mobile communication is used which preferably incorporates or includes a Subscriber Information Module (SIM) a card. A mobile communciation connection is established by at least one transaction partner to a service provider, by means of which first data relevant for the transaction and a credit or debit card number or an account number of a first transaction partner as well as the transaction amount are transmitted, with said information being confirmed by means of a digital signature and/or a PIN. Thereafter, second data including a credit or debit card number or aaccount number are entered by a second transaction partner from which the amount to be paid into the stated account of the first transaction partner is to be debited or into which the amount to be paid by the first transaction partner is to be credited, with these entries being confirmed by means of a digital signature and/or a PIN of the second transaction partner. The transaction is then executed.

### BACKGROUND OF THE INVENTION

The present invention relates to a method for the secure processing of financial transactions by means of wireless devices, especially devices for mobile communication.

Currently, there are several methods for electronic or wireless processing of business or financial transactions, for example, by means of the Internet, which is increasingly gaining in importance. Moreover, methods are known which allow financial transactions by means of a wireless telephone, such as a cellular telephone.

Credit cards are used with increasing frequency because they represent a very convenient method for processing business transactions, both for the purchaser as well as for the seller.

Direct debit processes from a desired account are also well known.

### SUMMARY OF THE INVENTION

A principal object of the present invention is to simplify wireless financial transactions, especially transactions which utilize a credit or debit card.

It is a further object of the present invention to provide a method which allows confirmations to be obtained from two or more persons for certain types of financial transactions.

These objects, as well as other objects which will become apparent from the discussion that follows, are achieved, in accordance with the present invention, by a method comprising the steps of:

(a) establishing a communication link between a first transaction partner and a service provider by means of a wireless device;

(b) transmitting to the service provider first data relevant to the transaction, including a credit or debit card number or account number of a first transaction partner, and the transaction amount;

(c) confirming this first data by providing a digital signature and/or a PIN of the first transaction partner;

(d) supplying to the service provider second data including a card number or account number of a second transaction partner from which the amount to be paid into the stated account of the first transaction partner is to be debited or into which the amount to be paid by the first transaction partner is to be credited;

(e) confirming the second data of the second transaction partner by providing a digital signature and/or a PIN of the second transaction partner; and

(f) executing the transaction.

It is proposed, for processing such financial transactions, to use a device for mobile communication, preferably in combination with a Subscriber Information Module (SIM) card.

In the description that follows, the transaction partners are referred to in the masculine “he”, “him” or “his”. It will be understood that the transaction partner can also be feminine (“she”, “her” or “hers”) or neuter (“it” or “its”) as in the case of a business entity.

According to a first embodiment of the present invention it is possible by means of a device for mobile communication, such as a wireless telephone for example, to perform a credit or debit card transaction or a direct debit or payment through an account.

To this end, a connection is established by means of the device for mobile communication by a first transaction partner to a service provider, such as a bank for example.

After the establishment of the connection, relevant data of the first transaction partner, preferably in encrypted form, are transmitted to the service provider. Such data are, for example, name, credit or debit card number, further credit card data, or also the data of the bank account of the first transaction partner. The transmission of such data can be monitored for time, so that on exceeding a predetermined interval, the transaction is terminated. It is optionally possible and desirable that the first transaction partner authenticate himself to the service provider by means of a digital signature by an optional entry of a personal identificatin number (PIN).

Preferably, the data to be transmitted are stored on the card disposed in the device, e.g. on the SIM card.

Thereafter, it is possible, depending on the desired type of transaction, to enter an amount of money which is to be paid into the account or is to be debited from the account or credit card. This entry can also be confirmed, e.g. by means of a digital signature and/or a pin.

In a further step, an account number or a credit card number is preferably entered by the second transaction partner from which the amount of money to be paid into the stated account of the first transaction partner is to be debited or into which the amount of money to be paid by the first transaction partner is to be credited.

In this connection, the second transaction partner can confirm this entry in accordance with the invention by means of his digital signature and/or a PIN. It is also possible to confirm the amount of the money.

Finally, the transaction established by the steps described above is performed or executed. It is also provided that the display of the device for mobile communication shows a transaction confirmation with all or a part of the transaction data. This transaction confirmation can also be printed out by means of a connectable printer device. It is also possible to send this confirmation to a further device for mobile communication of the first and/or second transaction partner.

In order to avoid the entry of account or credit/debit card data, the device for mobile communication may be equipped with an internal or external credit/debit card reader.

For certain types of transactions it may be appropriate or necessary to obtain a confirmation in the form of a permission or authorization of a further transaction partner who is not present. This may be the case, for example, when a child or family member wishes to debit or transfer an amount of money from a joint account or a joint credit card. It may be appropriate for youths in particular to obtain the parent's permission for such a business transaction, e.g. for transactions which exceed a certain predetermined amount of money. Moreover, such a procedure may be required for shareholders, authorized signatories or other employees of a company.

For this reason it is possible, within the scope of the method in accordance with the invention, namely in the case of a debit from a certain account which may also be a credit card account, to obtain the permission in an electronic manner from a business partner or a family member. For this purpose a step is provided that, after the establishment of the connection to the service provider and the entry of the account or credit card from which a certain sum is to be debited, e.g. within the scope of a transaction as explained above, the service provider on its part establishes a connection with a device for mobile communication of a further transaction partner whose confirmation is required in order to obtain this person's approval in the form of a digital signature and/or a PIN for the desired business transaction. For this purpose relevant data of the impending business transaction are sent to the further transaction partner. In accordance with the invention, the further transaction partner can then use his device for mobile communication to send his confirmation by means of a digital signature and/or a PIN, for example. It is also possible to send a refusal in a similar way. Should it not be possible to notify the further transaction partner directly, the request for confirmation can be stored on his device for mobile communication, or in the network like a conventional SMS message, which will reach the same once he is reachable again.

In accordance with another preferred embodiment of the invention, it is possible to obtain the confirmation prior to the actual time of transaction. In this process, a parent for example may confirm in advance, via an already established connection to a service provider, that the child may dispose of a certain sum from a certain account. Alternatively, a transaction partner may ask for the confirmation of a further transaction partner via the above-mentioned connection to the service provider. This can be displayed to the same by means of the display on his device for mobile communication for example.

Optionally, in order to increase security, it may be provided that the transmission of the transaction data occurs in an encrypted form, either entirely or partly.

According to a further advantageous embodiment of the present invention it is provided that, for processing a transaction, two devices for mobile communication are utilized which are connected sequentially or simultaneously with a service provider. This can concern same service provider or two different service providers which preferably should be able to communicate with each other.

In this case a connection is established to the service provider by a first transaction partner as explained above, with the relevant data such as an account number or a credit/debit card number being stated. As already mentioned, these entries can be confirmed by means of a digital signature and/or a PIN and can be provided with a time-out signal. Thereafter one can state an amount of money which is either to be debited or credited. A unique transaction number can then be assigned.

In order to obtain the approval of the second transaction partner, it is provided, within the scope of this embodiment of the invention, that the second transaction partner establish a connection to a service provider via his, or a further, device for mobile communication, which service provider can also be the same as the service provider for the first transaction partner. Then the second transaction partner is required to enter his relevant data, such as an account number or credit card number for payment or debit, accompanied by a confirmation in the form of a digital signature or a PIN for example. By entering the unique transaction number as provided to the second transaction partner by the first transaction partner, details of the transaction and an inquiry for a confirmation appear on the display. Following an optional correction of the amount of money or further data, the confirmation of the transaction can be performed in the form of a digital signature and/or a PIN.

In this case also, a confirmation of the transaction can appear on the display of at least one of the two transaction partners. Manipulations are excluded by assigning the unique transaction number.

The authorization of a further transaction partner can also be obtained for this form of transaction, in the manner described above.

It may also be provided that the authorizations of several transaction partners are obtained.

Alternatively it is possible to obtain a unique subscriber number following a one-off registration with a service provider or a service provider network. In this way a first transaction partner can enter the subscriber number of the second transaction partner for example after the entry of the transaction data. Finally, a connection is established to said second transaction partner by the service provider on the basis of the subscriber number, e.g. by means of a phone call or a connection to the device for mobile communication. From this point the second transaction partner can confirm or reject the transaction which is displayed to him. In this process he can enter, as already explained, the relevant data (account number, etc.) which can also be stored in the device or on the SIM card in the device. A confirmation is made by entering a digital signature and/or a PIN. A confirmation of a further transaction partner may also be required in accordance with the invention for this kind of transaction processing in the manner explained above.

In order to simplify transaction processing, relevant data of the user can be stored by the service provider. Such data are made available or used after the establishment of a connection and authentication by means of a PIN and/or a digital signature.

The connections to the service provider can be wireless connections of any kind. For example, instead of using the cellular telephone network, it is possible to establish a wireless Internet connection.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a representational block diagram of the system to which the method, according to the present invention, relates.

FIG. 2, comprised of FIGS. 2a and 2b, is a flow chart illustrating a first preferred embodiment of the present invention.

FIG. 3, comprised of FIGS. 3a, 3b and 3c, is a flow chart illustrating a second preferred embodiment of the present invention.

### DESCRIPTION OF THE PREFERRED EMBODIMENTS

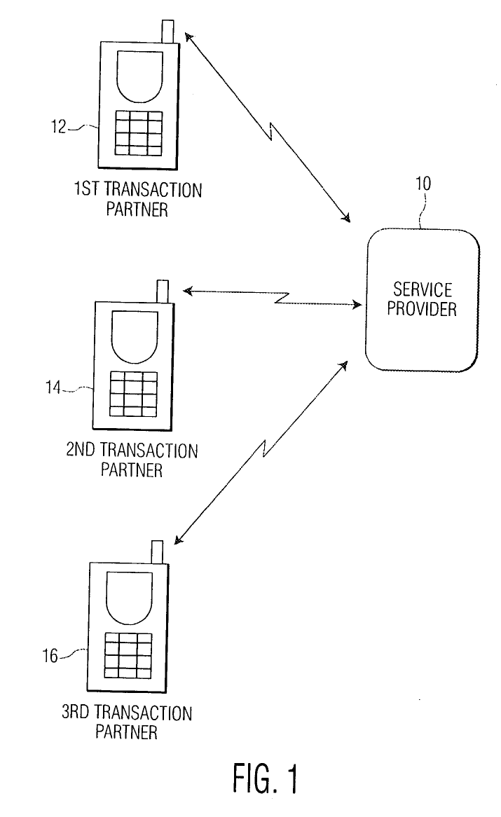

The preferred embodiments of the present invention will now be described with reference to FIGS. 1-3 of the drawings.

FIG. 1 depicts the system environment of the method according to the present invention. As is there shown, a service provider 10, which may be a bank, credit card company or the like, executes transactions for one or more “transaction partners” via wireless communication links with wireless devices such as cellular telephones 12, 14 and 16, each of which may incorporate a SIM card. The communication link may be established either by the transaction partner calling the service provider, or by the service provider calling the transaction partner.

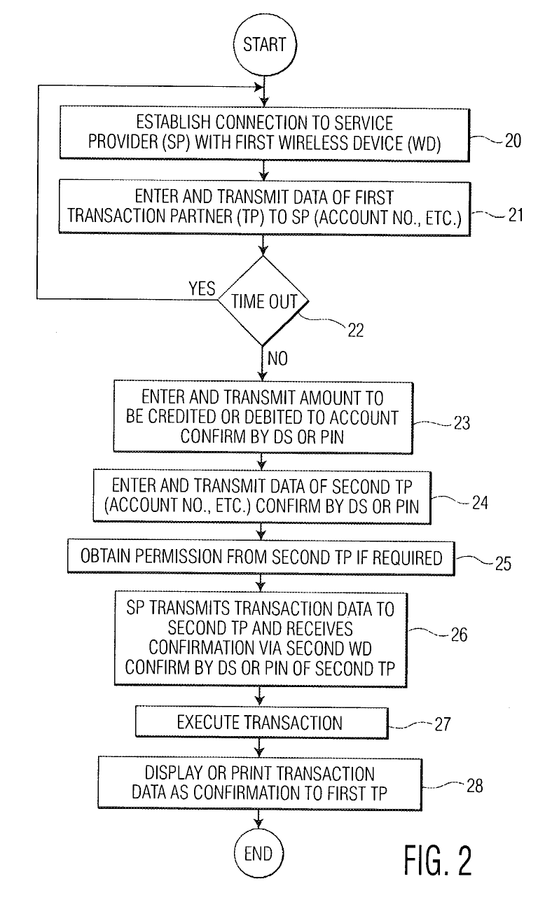

FIG. 2 illustrates how a transaction proceeds according to a first preferred embodiment of the present invention. If a first transaction partner wishes to transfer funds to a second transaction partner, he may start the process by establishing a connection to the service provider (block 20) using a cellular telephone. Thereafter, upon receipt of a prompt from the service provider, the first transaction partner enters the data relevant to the transaction, such as his credit or debit card number or account number (block 21). If the relevant data is not entered with a prescribed time (e.g., one minute) the connection is severed and must be established anew (block 22).

After the first transaction partner enters the account data, he is prompted to enter the amount to be debited from the account or, in the case of a transaction where a second transaction partner is to pay the first transaction partner, the amount to be credited to the account. Upon receipt of a prompt, the transaction amount is confirmed by the first transaction partner by entering either a digital signature (DS) or a personal identification number (PIN) (block 23).

Upon receipt of this confirmation, the service provider prompts the first transaction partner to identify the account of a second transaction partner to which or from which money is to be credited or debited, respectively. After this is done, and confirmed by DS or PIN (block 24) the service provider calls the second transaction partner, if required (for example, to debit funds from his account) to obtain his authorization (block 25). The service provider transmits, and the second transacation partner receives, the transaction data and, upon receipt of a prompt, the second transaction partner confirms and authorizes the transaction by entry of either his DS or PIN (block 26).

Thereafter, either the transaction is executed by the service provider (block 27) or, if the permission of the second transaction partner is not received, it is cancelled.

Finally, the transaction data is either printed and mailed to the first transaction partner or transmitted to the first transaction partner as a confirmation (block 28). This transaction information is also mailed and/or transmitted to the second transaction partner, if desired.

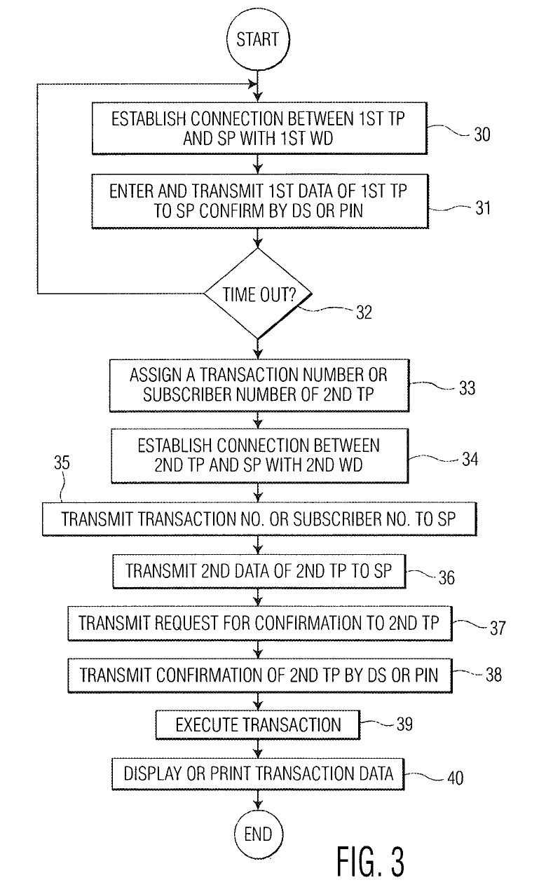

FIG. 3 shows how a transaction proceeds, according to a second preferred embodiment of the present invention, in the case where a transaction number is assigned to the transaction or a subscriber number is assigned to the second transaction partner.

As in the method illustrated in FIG. 2, a connection is first established between the first transaction partner and the service provider via the cellular telephone of the first transaction partner (block 30). Thereafter, the first transaction partner enters and transmits to the service provider a first set of data relevant to the transaction, including the debit or credit card number or account number of the first transaction partner and the transaction amount (block 31). The entry of this first set of data is confirmed by the first transaction partner, upon prompt by the service provider, by entering his DS or PIN and transmitting the same to the service provider. If the transaction data is not entered, and the confirmation provided, within a prescribed time (such as one minute) the service provider terminates the connection and the first transaction partner must start again (block 32).

Thereafter, if this confirmation occurs within the prescribed time, a unique transaction number is assigned to the transaction or a unique subscriber number is assigned to the second transaction partner (block 33). A connection is then established between the cellular telephone of the second transaction partner and the service provider (block 34). The transaction number or subscriber number is transmitted from the second transaction partner to the service provider (block 35) and the account data of the second transaction partner is transmitted to the service provider (block 36). Thereafter, upon prompt from the service provider (block 37) the second transaction partner transmits his confirmation of the transaction by DS or PIN (block 38).

Finally, the service provider executes the transaction (block 39) and displays or prints the transaction data (block 40).

There has thus been shown and described a novel method for processing transactions by means of wireless devices which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for processing transactions by means of wireless devices, especially devices for mobile communication, said method comprising the steps of:
(a) establishing a communication link between a first transaction partner and a service provider by means of a wireless device;
(b) transmitting to said service provider first data relevant to the transaction, including a credit or debit card number or account number of a first transaction partner, and the transaction amount;
(c) confirming said first data by providing at least one of a digital signature and a personal identification number (PIN) of the first transaction partner;
(d) supplying to said service provider second data including a credit or debit card number or account number of a second transaction partner from which the amount to be paid into the stated account of the first transaction partner is to be debited or into which the amount to be paid by the first transaction partner is to be credited;
(e) confirming said second data of the second transaction partner by providing at least one of a digital signature and a PIN of the second transaction partner; and
(f) executing the transaction.

2. A method for processing transactions by means of wireless devices, especially devices for mobile communication, said method comprising the steps of:
(a) establishing a first communication link between a first transaction partner and a service provider by means of a first wireless device;
(b) transmitting to said service provider first data relevant to the transaction, including a credit or debit card number or account number of a first transaction partner, and the transaction amount;
(c) confirming said first data by providing at least one of a digital signature and a personal identification number (PIN) of the first transaction partner;
(d) assigning a unique transaction number to the transaction at the service provider;
(e) establishing a second communication link between a second transaction partner and said service provider by means of a second wireless device;
(f) transmitting to said service provider second data including said transaction number and a credit or debit card number or account number of said second transaction partner from which the amount to be paid into the stated account of the first transaction partner is to be debited or into which the amount to be paid by the first transaction partner is to be credited;
(g) confirming said second data of the second transaction partner by providing at least one of a digital signature and a PIN of the second transaction partner; and
(h) executing the transaction.

3. A method as recited in claim 2, further comprising the steps of displaying details of the transaction and a query for confirmation on the wireless device of the second transaction partner, after entry of the transaction number, and confirming the transaction by providing at least one of a digital signature and a PIN by the second transaction partner.

4. A method for processing transactions by means of wireless devices, especially devices for mobile communication, said method comprising the steps of:
(a) establishing a communication link between a first transaction partner and a service provider by means of a first wireless device;
(b) transmitting to said service provider first data relevant to the transaction, including a credit or debit card number or account number of a first transaction partner, and the transaction amount;
(c) confirming said first data by providing at least one of a digital signature and a personal identification number (PIN) of the first transaction partner;
(d) assigning a unique subscriber number of a second transaction partner;
(e) establishing a second communication link between said second transaction partner and said service provider by means of a second wirelss device;
(f) transmitting to said service provider second data including said subscriber number;
(g) transmitting to said second transaction partner at least some of said first data;
(h) confirming said transaction by said second transaction partner by providing at least one of a digital signature and a PIN of the second transaction partner; and
(i) executing the transaction.

5. A method as recited in claim 1, wherein a confirmation of this transaction is required by a further transaction partner, in the case of a debit from a certain account.

6. A method as recited in claim 5, wherein after the establishment of a connection to the service provider and the entry of the account, credit or debit card number from which a certain amount is to be debited, the service provider establishes a connection to a further device for mobile communication of a further transaction partner whose confirmation is required, wherein the further transaction partner is shown relevant data of the proposed transaction with a request for confirmation in the form of a digital signature and/or a PIN for the desired transaction, and wherein the transaction is performed only after the confirmation is transmitted.

7. A method as recited in claim 6, wherein the confirmation is transmitted prior to the actual time of th transaction, with one transaction partner entering in advance the confirmation for approving the debit of a certain sum by means of a connection to a service provider by entering at least one of a digital signature and a PIN for the account or credit/debit card number from which a certain amount is to be debited.

8. A method as recited in claim 1, wherein the data is transmitted in partly or fully encrypted form.

9. A method as recited in claim 1, wherein at least a portion of the data are stored in the device for mobile communication.

10. A method as recited in claim 9, wherein at least a portion of the data are stored on a card disposed in the device.

11. A method as recited in claim 10, wherein the card is a SIM card.

12. A method as recited in claim 1, wherein the device for mobile communication is a wireless telephone.

13. A method as recited in claim 1, wherein relevant data of the transaction partners are stored by the service provider, which data are made available to the transaction partner after the establishment of a connection and an authentication by means of at least one of a digital signature or PIN.

14. A method as recited in claim 1, further comprising the step of displaying a transaction confirmation, with all or a part of the transaction data, on the wireless device of the first transaction.

15. A method as recited in claim 14, wherein the transaction confirmation is printed out by means of a printer device connected to said wireless device.

16. A method as recited in claim 1, wherein the transmission of the data is provided with a time signal, and wherein the transaction is terminated upon exceeding a predetermined time interval.
